(19) United States
(12) Patent Application Publication
(10) Pub. No.: US 2025/0256135 A1
(43) Pub. Date: Aug. 14, 2025

(54) BREATHING APPARATUS MONITORING

(71) Applicant: Dräger Safety AG & Co. KGaA, Lübeck (DE)

(72) Inventors: Thomas Eric Vardy, Howden (GB); Konstantinos Goutsos, NewCastle upon Tyne (GB); Larry Qing Lu, Leeds (GB); Dainius Narsutis, Northumbland (GB)

(21) Appl. No.: 19/047,996

(22) Filed: Feb. 7, 2025

(30) Foreign Application Priority Data
Feb. 8, 2024 (EP) 24386014.5

(51) Int. Cl. A62B 9/00; G08B 25/10

(52) U.S. Cl. CPC A62B 9/006; G08B 25/10

(57) ABSTRACT

There is provided a method for monitoring a breathing apparatus. The method may be performed by a wireless device of a network. The method may comprise, in response to obtaining first information, obtaining pressure consumption rate information based on the first information. The first information may comprise identity information of a wearer of a first breathing apparatus, a first pressure value associated with the first breathing apparatus, and information indicative that the first breathing apparatus is incapable of communicating with the wireless device. The method may also comprise, in response to obtaining first information, determining, based on the pressure consumption rate information and the first pressure value, a time discrete second pressure value associated with the first breathing apparatus.

### CROSS-REFERENCE TO RELATED APPLICATIONS

This application claims the priority of European Patent Application No. 24386014.5, filed on Feb. 8, 2024, and titled “BREATHING APPARATUS MONITORING”, which is hereby incorporated by reference in its entirety for all nonlimiting purposes.

### TECHNICAL FIELD

The present disclosure relates to methods for monitoring a wearer of a breathing apparatus and to devices configured to operate in accordance with those methods.

### BACKGROUND

Emergency services (e.g. fire services) are organisations that ensure public safety, security, and health by addressing and resolving different emergencies. As such, emergency services require every advantage possible when dealing with emergency response incidents. This is especially true as emergency services are required to respond to increasingly more complex incidents. Indeed, an emergency response incident can involve many individuals, including both responders and members of the public, and responders are commonly equipped with specialised equipment which must be carefully monitored and maintained in order to provide safety for the responders. For example, fire services regularly deal with toxic environments created by combustible materials, resulting in smoke, oxygen deficiency, elevated temperatures, poisonous atmospheres, and violent air flows. To combat some of these risks, firefighters carry breathing apparatus (BA). The proper management of such specialised equipment can mean the difference between a successful incident outcome and disaster.

Moreover, emergency services must be ready to adapt to an array of different environments (e.g. both natural and man-made), which cause further challenges with organising and effectively dealing with an incident. As such, ineffective management of such incidents can cause serious harm to the public and result in irreparable damage to infrastructure.

In the past, emergency services (e.g. fire services) have relied on analogue tools to monitor and control the handling of emergency response incidents. For example, an entry control operative (ECO) will commonly use a physical board (e.g. an entry control board (ECB)) for keeping track of fire fighters deployed at an incident (e.g. a building fire). In such a scenario, the ECO monitors the incident by physically organising the board with the help of “tallies”, which visibly show the name of the fire fighter being deployed at the incident and the time at which said fire fighter entered the incident. Thus, the tallies can be physical elements which are added and removed from the board to allow the ECO to keep track of the personnel deployed at an incident. The addition of a physical tally to the board can act as an incident registration for the corresponding firefighter. In addition to the physical board, the ECO commonly utilises walkie-talkies to manually control the incident and receive updates on the condition of personnel.

In recent years, some emergency services have adopted telemetry techniques which provide for enhanced communication between the personnel deployed at an incident. Specifically, emergency services personnel can be provided with equipment which enables (e.g. wireless) communication with other personnel and provides for the sharing of information describing the status of a wearer of said equipment, and of the equipment itself. As such, emergency services personnel can be provided with equipment that enables the transmission of vital information in real time to an ECO, which gives the ECO more time to make tactical, and potentially lifesaving decisions. Therefore, techniques utilising enhanced communication provide a significant advantage for the overall safety of individuals involved in the incident and provides greater reassurance for responders during a deployment.

However, there exist certain challenges associated with current techniques for monitoring incidents. In particular, although there have been advances in connectivity between individuals and entities operating at an incident, these advances have not been fully adopted, and therefore the management of an incident routinely involve the use of varying types of specialised equipment (e.g. different kinds of breathing apparatus). That is, a single incident may involve both telemetry and non-telemetry equipment. In this scenario, the telemetry equipment may be able to communicate with other telemetry equipment, whereas the non-telemetry equipment may not have any communicative functionality. As such, the above-mentioned advantages of enhanced communication are not experienced by all of the personnel involved at an incident. In fact, the management of the incident can actually be hampered by a lack of equipment compatibility, resulting in a lack of reassurance to those involved and causing detriment to health and safety. In some cases, an incident controller (e.g. an ECO) may be charged with handling multiple personnel each with a variety of different kinds of equipment. Due to the variety in the types of equipment used, the incident controller is required to perform various different tasks to appropriately monitor each of the individuals involved. As such, the role of the incident controller is made much more difficult, and this increased difficulty can lead to errors, which in turn can cause serious harm or even death.

### SUMMARY

As mentioned above, there are challenges associated with existing techniques for monitoring a wearer of a breathing apparatus. In a particular example, when a fire brigade uses breathing apparatuses that do not have telemetry capabilities, the ECO must manually write the pressure (e.g., of a breathing gas cylinder) associated with each firefighter on a physical form before they enter the incident and, at certain intervals in time, the ECO will radio each firefighter to confirm their current pressure. This process increases demands on the ECO, clogs communication channels and interrupts life-saving activities of the firefighters. It would thus be valuable to have an improvement aimed at addressing this challenge and the challenges mentioned above.

Therefore, according to a first aspect, there is provided a method for monitoring a wearer of a breathing apparatus. The method is performed by a wireless device of a network. The method comprises, in response to obtaining first information, obtaining, based on the first information, pressure consumption rate information. the method also comprises, in response to obtaining the first information, determining, based on the pressure consumption rate information and a first pressure value associated with the first breathing apparatus, a time discrete second pressure value associated with the first breathing apparatus. The first information comprises identity information of the wearer of the first breathing apparatus, the first pressure value, and information indicative that the first breathing apparatus is incapable of communicating with the wireless device.

According to a second aspect of the disclosure, there is provided a wireless device comprising processing circuitry configured to operate in accordance with the method described herein.

According to a third aspect of the disclosure, there is provided a computer program product, embodied on a non-transitory machine-readable medium. The computer program product comprises instructions which are executable by processing circuitry to cause the processing circuitry to perform the method described herein.

There are thus provided improved techniques for monitoring a wearer of a breathing apparatus. The techniques are improved since important parameters of the breathing apparatus can be monitored via a wireless device even though the breathing apparatus is incapable of communicating with the wireless device (e.g. via telemetry). Indeed, the improved techniques enable the automatic handling of incidents which involve a breathing apparatus which is configured to communicate via a network, and a breathing apparatus which is unable to connect to the network. In this way, a user of the wireless device is able to monitor and manage a live incident with greater ease. As a result, equipment, and wearers of said equipment, are managed in a more effective way, which consequently leads to improved likelihood of incident success and a decreased risk to the health and safety of the wearers.

### BRIEF DESCRIPTION OF THE DRAWINGS

Exemplary embodiments will now be described, by way of example only, with reference to the following drawings, in which:

FIG. 1 is a schematic illustration of a wireless device according to one or more examples;

FIG. 2 is a block diagram illustrating a method according to one or more examples; and

FIG. 3 is a block diagram illustrating a system according to one or more examples.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned above there is provided herein a technique for monitoring a wearer of a breathing apparatus (BA).

The BA referred to herein may be any type of BA. More specifically, the BA referred to herein may be any type of apparatus (e.g. device) which is worn by a wearer of the BA in order to provide a supply of breathable gas (e.g. air) to the wearer. As such, a BA can be advantageously utilised in an atmosphere that is immediately dangerous to life or health. In an example, the BA referred to herein may be a self-contained breathing apparatus (SCBA) and/or a compressed air breathing apparatus (CABA). The BA referred to herein may be a closed-circuit BA. Alternatively, the BA referred to herein may be an open-circuit BA. The BA referred to herein may comprise a lung demand regulator, a face mask, a compressed breathing gas tank, a control system, a first stage breathing circuit, a second stage breathing circuit, and/or a support frame, or any combination thereof.

The techniques described herein also involve a wireless device. The wireless device may be any type of wireless device. More specifically, the wireless device referred to herein may be any device configured to communicate wirelessly with one or more other entities (e.g. of the network referred to herein). For example, the wireless device may be a user equipment (UE). The wireless device referred to herein can include, but is not limited to, a smart device such as a smartphone or a tablet. The wireless device can be configured to run an application (or “app”) which, for example, enables the wireless device to communicate with one or more other entities of the network. The application may provide a user of the wireless device (e.g. an ECO) with the ability to manage and/or control an incident as described herein. The wireless device may be configured to enable the user to create, edit and/or view incident information. For example, the wireless device may be configured to enable the user of the wireless device to view one or more BAs of the network (e.g. deployed at the incident). Alternatively, or in addition, the wireless device may be configured to enable the user of the wireless device to (re)configure the one or more BAs and/or the respective one or more wearers of the one or more BAs into groups (e.g. teams). The reconfiguration can comprise, for example, assigning and/or removing a BA, and/or a wearer of the BA, to and/or from a group respectively. As such, the incident can be controlled and managed (e.g. centrally) using the wireless device.

The techniques described herein can be used in respect of any network, such as any communications or telecommunications network, e.g. cellular network. The network referred to herein may be a radio network. For example, the network referred to herein may be a 2.4 GHz radio network. In some examples, the network may comprise a Wi-Fi network (e.g. based on the Institute of Electrical and Electronics Engineers (IEEE) 802.11 family of standards). Alternatively, or in addition, the network may comprise a Bluetooth network (e.g. based on the IEEE 802.15.1 family of standards).

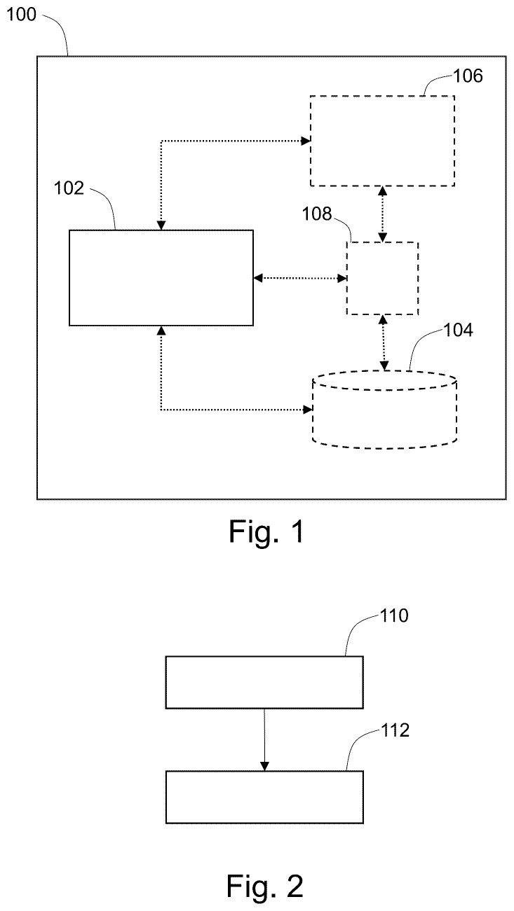

FIG. 1 illustrates a wireless device 100 according to an embodiment. The wireless device 100 can be for monitoring a wearer of a breathing apparatus.

As illustrated in FIG. 1, the wireless device 100 comprises processing circuitry (or logic) 102. The processing circuitry 102 controls the operation of the wireless device 100 and can implement the method described herein in respect of the wireless device 100. The processing circuitry 102 can be configured or programmed to control the wireless device 100 in the manner described herein.

The processing circuitry 102 can comprise one or more hardware components, such as one or more processors (e.g. one or more microprocessors, one or more multi-core processors, and/or one or more digital signal processors (DSPs)), one or more processing units, one or more processing modules, and/or one or more controllers (e.g. one or more microcontrollers). The one or more hardware components can be arranged on one or more printed circuit board assemblies (PCBAs) contained in one or more housing components. The one or more hardware components may be configured or programmed (e.g. using software or computer program code) to perform the various functions described herein in respect of the wireless device 100. In particular implementations, each of the one or more hardware components can be configured to perform, or is for performing, individual or multiple steps of the method described herein in respect of the wireless device 100. The processing circuitry 102 can be configured to run software to perform the method described herein in respect of the wireless device 100. The processing circuitry 102 can thus be implemented in numerous ways, with software and/or hardware, to perform the various functions described herein in respect of the wireless device 100.

Briefly, the processing circuitry 102 of the wireless device 100 is configured to, in response to obtaining first information, obtain, based on the first information, pressure consumption rate information. The processing circuitry 102 of the wireless device 100 is further configured to, in response to obtaining the first information, determine a time discrete second pressure value associated with a first breathing apparatus. The first information comprises identity information of a wearer of the first breathing apparatus, a first pressure value associated with the first breathing apparatus, and information indicative that the first breathing apparatus is incapable of communicating with the wireless device. The determination of the time discrete second pressure value is based on the pressure consumption rate information and the first pressure value.

As illustrated in FIG. 1, the wireless device 100 may optionally comprise a memory 104. Alternatively, the memory 104 may be external to (e.g. separate to or remote from) the wireless device 100. The memory 104 may comprise any type of non-transitory machine-readable medium, such as at least one cache or system memory. The memory 104 may comprise a volatile or a non-volatile memory. Examples of the memory 104 include, but are not limited to, a random access memory (RAM), a static RAM (SRAM), a dynamic RAM (DRAM), a read-only memory (ROM), a programmable ROM (PROM), an erasable PROM (EPROM), and an electrically erasable PROM (EEPROM), and/or any other memory.

The processing circuitry 102 can be communicatively coupled (e.g. connected) to the memory 104. The processing circuitry 102 may be configured to communicate with and/or connect to the memory 104. The memory 104 may be for storing program code or instructions which, when executed by the processing circuitry 102, cause the wireless device 100 to operate in the manner described herein. For example, the memory 104 may be configured to store program code or instructions that can be executed by the processing circuitry 102 to cause the wireless device 100 to operate in accordance with the method described herein in respect of the wireless device 100. Alternatively or in addition, the memory 104 can be configured to store any information, data, messages, requests, responses, indications, notifications, signals, or similar, that are described herein. The processing circuitry 102 may be configured to control the memory 104 to store information, data, messages, requests, responses, indications, notifications, signals, or similar, that are described herein.

As illustrated in FIG. 1, the wireless device 100 may optionally comprise a user interface 106. The user interface 106 can be configured to render (or output, display, or provide) information required by or resulting from the method described herein. For example, the user interface 106 may be configured to render (or output, display, or provide) any information, data, messages, requests, responses, indications, notifications, signals, or similar, that are described herein. Alternatively or in addition, the user interface 106 can be configured to receive a user input. For example, the user interface 106 may allow a user to manually enter information or instructions, interact with, and/or control the wireless device 100. Thus, the user interface 106 may be a user interface that enables the rendering (or outputting, displaying, or providing) of information and/or that enables a user to provide a user input.

The user interface 106 may comprise one or more components for rendering information and/or one or more components that enable the user to provide a user input. The one or more components for rendering information can comprise one or more visual components (e.g. a display or display screen, a graphical user interface (GUI) such as a touch screen, one or more lights such one or more light emitting diodes (LEDs), and/or any other visual component), one or more audio components (e.g. one or more speakers, and/or any other audio component), and/or one or more tactile/haptic components (e.g. a vibration function, or any other haptic/tactile feedback component), or any other user interface, or combination of user interfaces. The one or more components that enable the user to provide a user input can comprise one or more visual components (e.g. one or more switches, one or more buttons, a keypad, a keyboard, a mouse, a graphical user interface (GUI) such as a touch screen, and/or any other visual component), and/or one or more audio components (e.g. one or more microphones, and/or any other audio component), and/or one or more tactile/haptic components (e.g. a vibration function, or any other haptic/tactile feedback component), or any other user interface, or combination of user interfaces.

As illustrated in FIG. 1, the wireless device 100 may optionally comprise a communications interface (or communications circuitry) 108. The communications interface 108 can be communicatively coupled (e.g. connected) to the processing circuitry 102, the memory 104, and/or the user interface 106. Although the communications interface 108 and the user interface 106 are illustrated as separate interfaces, in other embodiments, the communications interface 108 may be part of the user interface 106. The processing circuitry 102 may be configured to communicate with and/or connect to the communications interface 108. In some embodiments, the processing circuitry 102 can be configured to control the communications interface 108 to operate in the manner described herein. The communications interface 108 can be for enabling the wireless device 100, or components of the wireless device 100 (e.g. the processing circuitry 102, the memory 104, the user interface 106, and/or any other components of the wireless device 100), to communicate with and/or connect to each other and/or one or more other components.

For example, the communications interface 108 may be operable to allow the processing circuitry 102 to communicate with and/or connect to the memory 104 and/or vice versa. Similarly, the communications interface 108 may be operable to allow the processing circuitry 102 to communicate with and/or connect to the user interface 106 and/or vice versa. Similarly, the communications interface 108 may be operable to allow the processing circuitry 102 to communicate with and/or connect to any one or more other entities (e.g. any one or more of the first network node referred to herein, the second network node referred to herein, the second breathing apparatus referred to herein, or any other entity) referred to herein. The communications interface 108 can be configured to transmit and/or receive information, data, messages, requests, responses, indications, notifications, signals, or similar, that are described herein. The processing circuitry 102 may be configured to control the communications interface 108 to transmit and/or receive information, data, messages, requests, responses, indications, notifications, signals, or similar, that are described herein.

The communications interface 108 may enable the wireless device 100, or components of the wireless device 100, to communicate and/or connect in any suitable way. For example, the communications interface 108 may enable the wireless device 100, or components of the wireless device 100, to communicate and/or connect wirelessly, via a wired connection, or via any other communication (or data transfer) mechanism. In some wireless implementations, for example, the communications interface 108 may enable the wireless device 100, or components of the wireless device 100, to use radio frequency (RF), Wi-Fi, Bluetooth, or any other wireless communication technology to communicate and/or connect. In some examples, the communications interface 108 may comprise a proprietary radio module.

Although the wireless device 100 is illustrated in FIG. 1 as comprising a single memory 104, it will be appreciated that the wireless device 100 may comprise at least one memory (i.e. a single memory or a plurality of memories) 104 that operate in the manner described herein. Similarly, although the wireless device 100 is illustrated in FIG. 1 as comprising a single user interface 106, it will be appreciated that the wireless device 100 may comprise at least one user interface (i.e. a single user interface or a plurality of user interfaces) 106 that operate in the manner described herein. Similarly, although the wireless device 100 is illustrated in FIG. 1 as comprising a single communications interface 108, it will be appreciated that the wireless device 100 may comprise at least one communications interface (i.e. a single communications interface or a plurality of communications interfaces) 108 that operate in the manner described herein. It will also be appreciated that FIG. 1 only shows the components required to illustrate an embodiment of the wireless device 100 and, in practical implementations, the wireless device 100 may comprise additional or alternative components to those shown.

FIG. 2 illustrates a method according to an embodiment. The method is for monitoring a wearer of a breathing apparatus. The wireless device 100 described earlier with reference to FIG. 2 can be configured to operate in accordance with the method. For example, the method can be performed by or under the control of the processing circuitry 102 of the wireless device 100. The method described herein may be a computer-implemented method.

With reference to FIG. 2, at block 110, in response to obtaining first information, pressure consumption rate information is obtained based on the first information. More specifically, the wireless device 100 (e.g. the processing circuitry 102 of the wireless device 100) obtains the pressure consumption rate information based on the first information. The first information comprises identity information of a wearer of a first breathing apparatus, a first pressure value associated with the first breathing apparatus, and information indicative that the first breathing apparatus is incapable of communicating with the wireless device 100.

The first information comprises information indicative that the first breathing apparatus is incapable of communicating with the wireless device 100. Herein, the first breathing apparatus may be incapable of communicating with the wireless device 100 if the first breathing apparatus is unable to either directly or indirectly communicate with the wireless device 100. For example, the first breathing apparatus is incapable of communicating with the wireless device if the first breathing apparatus is incapable of communicating with the wireless device via an intermediary entity (e.g. between the first breathing apparatus and the wireless device). In some scenarios, the first breathing apparatus may be incapable of communicating with the wireless device if the first breathing apparatus is not configured with to communicate (e.g. via a network) with any entity. For example, the first breathing apparatus may be incapable of transmitting information, data, messages, requests, responses, indications, notifications, signals, or similar (e.g. towards the wireless device 100). The first breathing apparatus may be referred to herein as a “non-telemetry” breathing apparatus. As such, the first breathing apparatus may not be configured with telemetry functionality.

The first information comprises identity information of the wearer of the first breathing apparatus. The identity information may be any type of identity information of the wearer of the first breathing apparatus. For example, the identity information of the wearer of the first breathing apparatus may comprise one or more of a wearer identifier (ID), a username (e.g. for the wearer), an equipment ID (e.g. for the first breathing apparatus), and an equipment model (e.g. corresponding to the first breathing apparatus).

The first information also comprises a first pressure value associated with the first breathing apparatus. A “pressure value”, as referred to herein, may correspond to a pressure of a breathing gas cylinder of a breathing apparatus. As such, the first pressure value associated with the first breathing apparatus may correspond to a pressure of a breathing gas cylinder of the first breathing apparatus. In some examples, the first pressure value associated with the first breathing apparatus may be indicative of a (e.g. remaining) volume of breathable gas stored in the first breathing apparatus. As such, the first pressure value associated with the first breathing apparatus may correspond to an amount of breathable gas remaining in the first breathing gas at the point in time at which the first information is received (e.g. by the wireless device 100). For example, the first pressure value can be a pressure value between 0 bar and 450 bar (e.g. depending on the use of the first breathing apparatus). Upon initial use of the first breathing apparatus (e.g. at the beginning of an incident), the first breathing apparatus may be full (e.g. at maximum capacity). In such a scenario, the first pressure value may typically be in the range of 300 bar to 450 bar. The maximum capacity of the first breathing apparatus (e.g. in terms of first pressure value) can depend on the storage (e.g. air cylinder) configuration of the first breathing apparatus.

As mentioned above, the method comprises obtaining, based on the first information, pressure consumption rate information. The pressure consumption rate information may be indicative of a rate of change of pressure over time. For example, the pressure consumption rate information may be indicative of a rate of depletion of a pressure value (e.g. of a breathing apparatus, such as the first breathing apparatus referred to herein). In some examples, the pressure consumption rate information comprises a pressure consumption rate value. The pressure consumption rate value may be a constant value. The pressure consumption rate information may be configurable (e.g. by a user of the wireless device 100). Therefore, in some examples, the pressure consumption rate information may comprise a constant, predetermined pressure consumption rate value. In some examples, the pressure consumption rate can depend on the wearer of the first breathing apparatus (e.g. based on the wearer's activity and/or level of exertion). Typically, the pressure consumption rate may correspond to a pressure consumption rate value of 10 L/min to 100 L/min (e.g. of breathable air contained in the first breathing apparatus). A normal (e.g. good or preferable) pressure consumption value rate may be 60 L/min.

The pressure consumption rate information is obtained based on the first information. As such, the pressure consumption rate information may be obtained based on some or all of the information comprised in the first information. For example, the pressure consumption rate information may be obtained based on one or more of the identity information of the wearer of the first breathing apparatus, the first pressure value, and the information indicative that the first breathing apparatus is incapable of communicating with the wireless device. In some examples, the pressure consumption rate information may be obtained on at least the identity information of the wearer of the first breathing apparatus. As such, the obtained pressure consumption rate information may be customised based on the wearer of the first breathing apparatus. For example, the pressure consumption rate information may comprise an average breathing rate for the wearer of the first breathing apparatus. In such examples, the obtaining of the pressure consumption rate information may be based on age, height, weight, and/or any other physiological parameters of the wearer of the first breathing apparatus. The pressure consumption rate information may be obtained (e.g. determined) empirically and/or analytically based on one or more physiological parameters of the user.

In some examples, obtaining the pressure consumption rate information may comprise using a formula and/or or a lookup table to determine the pressure consumption rate information (e.g. a pressure consumption rate value).

In some examples, the information indicative that the first breathing apparatus is incapable of communicating with the wireless device 100 may act as a triggering condition for the pressure consumption rate information being obtained. As such, the pressure consumption rate information may be obtained (e.g. automatically) in response to identifying that the first breathing apparatus is incapable of communicating with the wireless device 100.

At block 112 of FIG. 2, in response to obtaining the first information, a time discrete second pressure value associated with the first breathing apparatus is determined. More specifically, the wireless device 100 (e.g. the processing circuitry 102 of the wireless device 100) determines the time discrete second pressure value. The determination of the time discrete second pressure value is based on the pressure consumption rate information described herein, and the first pressure value described herein. In this way, the wireless device advantageously determines (e.g. estimates) a (e.g. continuous) pressure value associated with the first breathing apparatus. As such, the wireless device is able to monitor the operation and viability of use of the first breathing apparatus, even though the first breathing apparatus is incapable of communicating with the wireless device. Thus, the method automates a previously manual process that is prone to human error. In an example in which the user of the wireless device is an incident controller (e.g. an ECO), then the ECO can be provided with an (e.g. up-to-date) pressure value for the first breathing apparatus and, as such, can effectively monitor all types of breathing apparatus present at an incident.

Herein, a time discrete value may be defined as a value corresponding to an instantaneous moment in time. Alternatively, or in addition, a time discrete value may correspond to a value determined periodically and/or continuously with respect to time. As such, in an example, determining a time discrete value, as described herein, may comprise determining one or more values over time. In some scenarios, the time discrete second pressure value can be determined periodically and/or continuously.

In some examples, obtaining the pressure consumption rate information may comprises obtaining the pressure consumption rate information from a memory of the wireless device 100 (e.g. the memory 104 of the wireless device 100). In these examples, the wireless device may store pressure consumption rate information (e.g. corresponding to one or more breathing apparatus wearers). Alternatively, or in addition, obtaining the pressure consumption rate information may comprise receiving the pressure consumption rate information from a first network node of the network. The wireless device (e.g. the processing circuitry 102 of the wireless device 100) can perform the receiving (e.g. via the communications interface 108 of the wireless device 100). The first network node may be a base station of the network. For example, the first network node may be a base station deployed at an incident at which the wearer of the first breathing apparatus is deployed. In some examples, the first network node may be a server of the network. For example, the first network node may be a cloud server of the network.

Obtaining the pressure consumption rate may comprise initiating transmission of a request for the pressure consumption rate information towards the first network node as described herein. As such, in some examples, the pressure consumption rate information may be received from the first network node in response to a request for the pressure consumption rate information. The step of initiating transmission of the request towards the first network node may be performed in response to the obtaining the first information. Herein, the term “initiate” can mean, for example, cause or establish. Thus, any reference to an entity (e.g. the wireless device 100) “initiating transmission” will be understood to mean that the entity (e.g. the processing circuitry of the entity) can be configured to itself transmit (e.g. via a communications interface of the entity) or can be configured to cause another entity to transmit.

Although not illustrated in FIG. 2, in some examples the method may comprise receiving, from a second breathing apparatus of the network, a third pressure value associated with the second breathing apparatus. That is, the wireless device 100 (e.g. the processing circuitry 102 of the wireless device 100) may receive the third pressure value (e.g. via the communications interface 108 of the wireless device 100). The third pressure value may be a time discrete pressure value, as defined herein.

Thus, in some examples, the wireless device 100 may be configured to communicate with one or more breathing apparatuses of the network (e.g. the second breathing apparatus). As such, the wireless device can be configured to monitor both telemetry and non-telemetry breathing apparatuses. Therefore, the wireless device can be configured to operate in a “mixed user” system which, advantageously, does not require each wearer of a breathing apparatus to commit to the same type of breathing apparatus (e.g. entirely telemetry breathing apparatus or entirely non-telemetry breathing apparatus). This is particularly useful when applied to a firefighter context, since an ECO is able to manage an incident involving multiple firefighters (e.g. from various teams and/or units) operating various types of equipment.

Although not illustrated in FIG. 2, the method may comprise displaying the time discrete second pressure value, as defined herein, via a display of the wireless device 100. That is, the wireless device 100 (e.g. the processing circuitry 102 of the wireless device 100) may display the time discrete second pressure value via the display of the wireless device 100 (e.g. the user interface 106 of the wireless device 100). The display of the wireless device 100 may be the user interface 106 of the wireless device 100 referred to herein. As such, a user of the wireless device 100 can be provided with a display of the time discrete second pressure value, which enables the user to actively monitor the status of the wearer and the first breathing apparatus. Since the first breathing apparatus is incapable of communicating with the wireless device, the wireless device is unable to receive updates regarding the parameters of the first breathing apparatus. However, the method described herein allows a user of the wireless device 100 to quickly confirm a pressure value of the first breathing apparatus and may (e.g. automatically) alert a user of the wireless device 100 when action needs to be taken in response to said pressure value (e.g. contacting the wearer of the first breathing apparatus in order to get an (e.g. pressure) updated).

Although also not illustrated in FIG. 2, the method may comprise displaying the third pressure value, as defined herein, via the display of the wireless device 100. That is, the wireless device 100 (e.g. the processing circuitry 102 of the wireless device 100) may display the third pressure value via the display of the wireless device (e.g. the user interface 106 of the wireless device 100). As such, a user of the wireless device 100 can be provided with a display of the third pressure value, which enables the user to actively monitor the status of the wearer and the second breathing apparatus. In some examples, both the time discrete second pressure value and the third pressure value may be displayed at the same time. Thus, the user is able to actively monitor both telemetry and non-telemetry equipment via the wireless device 100.

Although not illustrated in FIG. 2, the method may comprise providing a first screen via the display of the wireless device. The first screen may comprise a first user block associated with the first breathing apparatus, and a second user block associated with the second breathing apparatus. The first user block may comprise an indication that the first breathing apparatus is incapable of communicating with the wireless device 100. Alternatively, or in addition, the second user block may comprise an indication that the second breathing apparatus is capable of communicating with the wireless device 100. As such, the display of the wireless device 100 can be indicative of a clear differentiation between the first breathing apparatus and the second breathing apparatus. In this way, the display of the wireless device 100 enables a user of the wireless device 100 to clearly differentiate between telemetry and non-telemetry breathing apparatus wearers (e.g. firefighters).

The wireless device 100 (e.g. the display of the wireless device 100) can be configured to allow a user of the wireless device 100 (e.g. an ECO) to organise breathing apparatuses and/or respective wearers of the breathing apparatuses into groups (teams). For example, the wireless device 100 may be configured to enable the movement of the first user block and/or the second user block to organise the associated breathing apparatus into teams. In these examples, the display of the wireless device 100 may be a touch screen display (e.g. of a smart device, such as a phone, tablet, etc.). Such functionality helps to keep the information in a format that is easy to digest for the user. Indeed, the wireless device 100 allows the user to reorganise the breathing apparatus wearers (e.g. firefighters) within one or more teams very easily (e.g. before and/or after the breathing apparatus wearers are deployed at an incident). As mentioned herein, the wireless device 100 advantageously allows the user of the wireless device 100 to combine telemetry and non-telemetry breathing apparatus wearers within the same device, which previously would have to involve two different systems for managing the different types of breathing apparatus.

Although not illustrated in FIG. 2, in some examples, the method may comprise displaying, via the display of the wireless device 100, an amount of time elapsed since obtaining the first information. As described herein, the first information comprises the first pressure value, and so the amount of time elapsed since obtaining the first information can correspond to a time elapsed since receiving the first pressure value associated with the first breathing apparatus. Therefore, in some examples, the wireless device 100 can display how much time has passed since the last time the pressure of the first breathing apparatus was obtained (e.g. updated). As such, it is simple for a user of the wireless device 100 to track how up-to-date pressure values are, and if a breathing apparatus pressure has not been obtained (e.g. confirmed) within a predetermined configurable amount of time. As such, the user of the wireless device 100 (e.g. an ECO) is advantageously prevented from forgetting to update pressure values for any breathing apparatus wearers that they may be responsible for.

Although also not illustrated in FIG. 2, in some examples, the method may comprise, in response to determining that the time discrete second pressure value meets a first criterion, generating an alert indicating that the first criterion has been met. The alert may comprise an alarm and/or a distress signal. In some examples, the alert can comprise one or more of a visual alert, an auditory alert, and a haptic alert. For example, generating a visual alert indicating that the first criterion has been met may comprise outputting (e.g. via the display of the wireless device 100) information indicative that the first criterion has been met. Generating an auditory alert may, for example, comprise outputting an audio signal indicative of the alert (e.g. siren and/or a voice recording). Generating a haptic alert indicative may, for example, comprise actuating a vibrating element (e.g. user interface) of the wireless device 100.

The first criterion may be met if the time discrete second pressure value meets a pre-defined level. For example, the time discrete second pressure value may meet the first criterion if, for example, the time discrete second pressure value is less than or equal to a first pressure threshold value. Thus, meeting the first criterion may be indicative that the pressure value of the first breathing apparatus has reached a lower limit, such as an unsafe pressure value. In some examples, meeting the first criterion may be indicative that the time discrete second pressure value is a concern. For example, the first pressure threshold value may be 55 bar. Such a first pressure value may be associated with an unsafe first pressure value for the wearer of the first breathing apparatus. It will be understood that the first pressure threshold value may be configurable. For example, the first pressure threshold value may be configurable via (e.g. a user of) the wireless device 100 referred to herein. As such, a user of the wireless device 100 (e.g. an ECO) can have the ability to customise the first criterion (e.g. the first pressure threshold value). Thus, the generation of the alert indicating that the first criterion has been met may inform the user of the wireless device 100 that they need to perform some remedial action in relation to the first breathing apparatus and/or the wearer of the first breathing apparatus. The remedial action can comprise, for example, contacting the wearer of the first breathing apparatus (e.g. via a radio link) to request a pressure update. Alternatively, or in addition, the alert may be an evacuation alert which may, for example, alert the user of the wireless device 100 that the wearer of the first breathing apparatus should be evacuated from an incident.

In some examples, the method may comprise obtaining the first information as described herein. Obtaining the first information may comprise obtaining the first information via the user interface 106 of the wireless device 100. In examples in which the user interface 106 of the wireless device 100 comprises a touch screen (e.g. a touch screen display), the first information may be obtained via the touch screen. As such, a user of the wireless device 100 can input the first information, as described herein, into the wireless device 100. The input can be made before or upon deployment of a breathing apparatus wearer (e.g. the wearer of the first breathing apparatus) to an incident. In this way, once the wearer's (e.g. firefighter's) pressure is confirmed (e.g. via input via the user interface 106 of the wireless device 100), the time discrete temperature value of the breathing apparatus can be redetermined automatically (e.g. by decreasing the pressure at a predetermined configurable rate), which provides the user of the wireless device 100 with an automatic and updated pressure value for the breathing apparatus.

Although not illustrated in FIG. 2, in some examples, the method may comprise initiating transmission of a first message towards a second network node of the network. The wireless device 100 (e.g. the processing circuitry 102 of the wireless device 100) can initiate transmission of the first message. The first message may comprise the first information. Alternatively, or in addition, the first message may comprise the time discrete second pressure value. The second network node may be the same as the first network node referred to herein. For example, the second network node may be a cloud server. Therefore, in some examples, the wireless device 100 may initiate transmission of the first message towards a cloud server. The transmission of the first message can be performed periodically and/or continuously. In some examples, the transmission of the first message may be initiated in response to an input indicative that the monitoring of one or more breathing apparatus wearers is terminated (e.g. at an end of an incident).

As such, the wireless device 100 may automatically upload (e.g. log and/or store) information (e.g. for every event event) for both telemetry and non-telemetry breathing apparatus wearers. Thus, the wireless device 100 can provide remote monitoring functionality. In a particular example, the state of all telemetry and non-telemetry breathing apparatus wearers (e.g. firefighters) may be periodically pushed to the cloud so that the state of said wearers can be viewed remotely (e.g. at an incident control center). This remote monitoring can therefore be performed live during an incident. As such, managing large incidents involving multiple wireless devices (e.g. and multiple users of the wireless devices, such as ECOs) is made much easier. Once the monitoring of the method is terminated (e.g. at the end of an incident) the wireless device may generate a full incident report generated from all the events and/or information associated with the incident. The full incident report can be transmitted (e.g. pushed) to the cloud server referred to herein, allowing others to view the full incident report. The full incident report can be advantageously combined with full incident reports from other wireless devices from the same incident.

There is also provided a system. The system can comprise any one or more of the wireless device 100 described herein, the first breathing apparatus described herein, the second breathing apparatus described herein, the first network node described herein, and the second network node described herein.

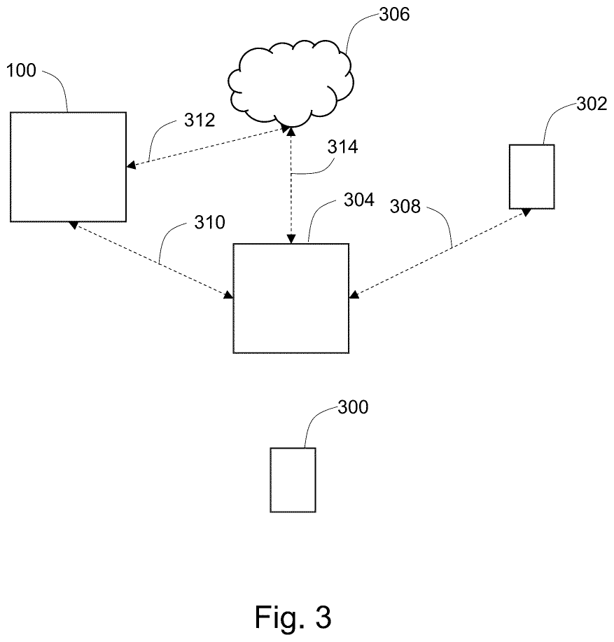

FIG. 3 illustrates a system according to an embodiment. The system illustrated in FIG. 3 comprises a wireless device 100, a first breathing apparatus 300, a second breathing apparatus 302, a base station 304, and a cloud server 306. In the system illustrated in FIG. 3, the wireless device may operate as described further with reference to FIGS. 1 and 2. The base station 304 may be configured to operate as the first network node and/or the second network node as referred to herein. Alternatively, or in addition, the cloud server 306 may be configured to operate as the first network node and/or the second network node as referred to herein.

The system illustrated in FIG. 3 comprises a single first breathing apparatus 300 and a single second breathing apparatus 302, however it will be understood that this is merely an example and that, in other examples, the system may comprise any number of first breathing apparatuses and/or any number of second breathing apparatuses.

As illustrated by arrows 308, 310, 312 and 314 of FIG. 3, the wireless device 100, the second breathing apparatus 302, the base station 304, and the cloud server 306 are configured to directly and/or indirectly communicate with each other via the network referred to herein. As such, the wireless device 100, the second breathing apparatus 302, the base station 304, and the cloud server 306 may be referred to as telemetry equipment. As illustrated by the lack of arrow between the wireless device 100 and the first breathing apparatus 300, the first breathing apparatus 300 is incapable of communicating with the wireless device (e.g. via the network). As such, the first breathing apparatus 300 may be referred to as non-telemetry equipment.

As illustrated by arrows 308 and 310 of FIG. 3, the wireless device 100 can communicate with the second breathing apparatus 302 via the base station 304. However, it will be understood that the wireless device 100 may communicate with the second breathing apparatus directly (e.g. with no intermediary entity) according to other examples. As described herein, in some examples, the wireless device 100 may receive information (e.g. the third pressure value defined herein) from the second breathing apparatus 302.

As mentioned above, the base station 304 and/or the cloud server 306 may be configured as the first network node as referred to herein. Therefore, as illustrated by arrows 310 and 312, in some examples the wireless device 100 may receive the pressure consumption rate information, as defined herein, from the base station 304 and/or the cloud server 306. In some examples, the wireless device 100 may receive the pressure consumption rate information from the cloud server 306 via the base station 304 (e.g. via arrow 314 of FIG. 3), and vice-versa.

As also mentioned above, the base station 304 and/or the cloud server 306 may be configured as the second network node as referred to herein. Therefore, as illustrated by arrows 310 and 312, in some examples the wireless device 100 may initiate transmission of the first message, as defined herein, towards the second network node. In some examples, the wireless device 100 may initiate transmission of the first message to the cloud server 306 via the base station 304 (e.g. via arrow 314 of FIG. 3), and vice-versa.

Therefore, the system illustrated in FIG. 3 shows an example system for monitoring (e.g. and managing) telemetry and non-telemetry equipment (e.g. breathing apparatuses) alongside one another in one system. The use of the wireless device 100 (e.g. within the system) saves time for a user (e.g. ECO) of the wireless device 100 tasked with controlling the equipment (e.g. breathing apparatuses) by automating a previously manual process. Moreover, the wireless device 100 enables multiple pieces of information, from various types of equipment to be consolidated into one place.

There is also provided a computer program embodied on a non-transitory machine-readable medium. The non-transitory machine-readable medium comprises instructions. The instructions are executable such that, on execution by a suitable computer or processor, the computer or processor is caused to perform the method described herein. The non-transitory machine-readable medium may be, for example, any entity or device capable of carrying the computer program product. For example, the non-transitory machine-readable medium may include a data storage, such as a ROM (such as a CD-ROM or a semiconductor ROM) or a magnetic recording medium (such as a hard disk). Furthermore, the non-transitory machine-readable medium may be a transmissible carrier, such as an electric or optical signal, which may be conveyed via electric or optical cable or by radio or other means. When the computer program product is embodied in such a signal, the non-transitory machine-readable medium may be constituted by such a cable or other device or means. Alternatively, the non-transitory machine-readable medium may be an integrated circuit in which the computer program product is embedded, the integrated circuit being adapted to perform, or used in the performance of, the method described herein.

The techniques described herein facilitate the automatic monitoring of a pressure value associated with a breathing apparatus, even when said breathing apparatus is unable to communicate with a monitoring device via telemetry means. As such, non-telemetry enabled breathing apparatuses can be effectively monitored by a wireless device that is configured to communicate with other breathing apparatus via a network connection. As such, the techniques described herein provide for an automated system that is able to monitor both telemetry and non-telemetry breathing apparatus simultaneously. The techniques described herein therefore provide for the automation of a previously manual process of manually measuring and calculating pressure values by hand for each breathing apparatus wearer. In this way, the techniques free the user of the wireless device to concentrate on interacting and controlling the more critical aspects of an incident at which breathing apparatus are deployed, instead of having to spend time calculating, for example, retreat pressures, and/or estimating breathing apparatus pressures in their head.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1-15. (canceled)

16. A method for monitoring a breathing apparatus, wherein the method is performed by a wireless device of a network, the method comprising:
receiving first information, wherein the first information comprises identity information of a wearer of a first breathing apparatus, a first pressure value associated with the first breathing apparatus, and information indicative that the first breathing apparatus is incapable of communicating with the wireless device; and
in response to receiving the first information:
receiving, based on the first information, pressure consumption rate information;
determining, based on the pressure consumption rate information and the first pressure value, a time discrete second pressure value associated with the first breathing apparatus; and
causing, based on determining the time discrete second pressure value, display of the time discrete second pressure value via a display of the wireless device.

17. The method of claim 16, wherein receiving the pressure consumption rate information comprises at least one of:
receiving the pressure consumption rate information from a memory of the wireless device; or
establishing a connection between the wireless device and a network node of the network, and in response:
receiving the pressure consumption rate information from the network node of the network.

18. The method of claim 16, further comprising:
establishing a connection between the wireless device and a second breathing apparatus of the network; and
receiving, from the second breathing apparatus, a third pressure value associated with the second breathing apparatus.

19. The method of claim 18, further comprising:
causing display of the third pressure value via the display of the wireless device.

20. The method of claim 19, further comprising:
providing a first screen via the display of the wireless device, wherein the first screen comprises:
a first user block associated with the first breathing apparatus; and
a second user block associated with the second breathing apparatus,
wherein the first user block comprises an indication that the first breathing apparatus is incapable of communicating with the wireless device.

21. The method of claim 16, further comprising:
causing, via the display of the wireless device, display of an amount of time elapsed since obtaining the first information.

22. The method of claim 16, wherein the time discrete second pressure value is determined periodically.

23. The method of claim 16, wherein the time discrete second pressure value is determined continuously.

24. The method of claim 16, further comprising:
comparing the time discrete second pressure value to a first criterion; and
in response to determining, based on the comparing, that the time discrete second pressure value meets the first criterion:
generating an alert indicating that the first criterion has been met.

25. The method of claim 24, wherein the determining that the time discrete second pressure value meets the first criterion comprises:
determining whether the time discrete second pressure value is less than or equal to a first pressure threshold value.

26. The method of claim 16, wherein the receiving the first information comprises receiving the first information via a user interface of the wireless device.

27. The method of claim 16, further comprising:
establishing a connection between the wireless device and a network node of the network; and
initiating transmission of a first message towards the network node of the network, wherein the first message comprises at least one of:
the first information; or
the time discrete second pressure value.

28. The method of claim 16, wherein the pressure consumption rate information comprises an average breathing rate for the wearer of the first breathing apparatus.

29. A wireless device comprising:
processing circuitry; and
memory storing instructions that, when executed by the processing circuitry, configure the wireless device to:
receive first information, wherein the first information comprises identity information of a wearer of a first breathing apparatus, a first pressure value associated with the first breathing apparatus, and information indicative that the first breathing apparatus is incapable of communicating with the wireless device; and
in response to receiving the first information:
receive, based on the first information, pressure consumption rate information;
determine, based on the pressure consumption rate information and the first pressure value, a time discrete second pressure value associated with the first breathing apparatus; and
cause, based on determining the time discrete second pressure value, display of the time discrete second pressure value via a display of the wireless device.

30. The wireless device of claim 29, wherein the instructions, when executed by the processing circuitry, configure the wireless device to receive the pressure consumption rate information by performing at least one of:
receiving the pressure consumption rate information from a memory of the wireless device; or
establishing a connection between the wireless device and a network node of the network, and in response:
receiving the pressure consumption rate information from the network node of the network.

31. The wireless device of claim 29, wherein the instructions, when executed by the processing circuitry, further configure the wireless device to:
establish a connection between the wireless device and a second breathing apparatus;
receive, from the second breathing apparatus, a third pressure value associated with the second breathing apparatus;
cause display of the third pressure value via the display of the wireless device; and
provide a first screen via the display of the wireless device, wherein the first screen comprises:
a first user block associated with the first breathing apparatus; and
a second user block associated with the second breathing apparatus,
wherein the first user block comprises an indication that the first breathing apparatus is incapable of communicating with the wireless device.

32. The wireless device of claim 29, wherein the instructions, when executed by the processing circuitry, further configure the wireless device to:
compare the time discrete second pressure value to a first criterion; and
in response to determining, based on the comparing, that the time discrete second pressure value meets the first criterion:
generate an alert indicating that the first criterion has been met.

33. A computer program product, embodied on a non-transitory machine-readable medium, comprising instructions which are executable by processing circuitry to cause:
receiving, by a wireless device, first information, wherein the first information comprises identity information of a wearer of a first breathing apparatus, a first pressure value associated with the first breathing apparatus, and information indicative that the first breathing apparatus is incapable of communicating with the wireless device; and
in response to receiving the first information:
receiving, based on the first information, pressure consumption rate information;
determining, based on the pressure consumption rate information and the first pressure value, a time discrete second pressure value associated with the first breathing apparatus; and
causing, based on determining the time discrete second pressure value, display of the time discrete second pressure value via a display of the wireless device.

34. The computer program product of claim 33, wherein receiving the pressure consumption rate information comprises at least one of:
receiving the pressure consumption rate information from a memory of the wireless device; or
establishing a connection between the wireless device and a network node of the network, and in response:
receiving the pressure consumption rate information from the network node of the network.

35. The computer program product of claim 33, wherein the instructions are executable by the processing circuitry to further cause:
establishing a connection between the wireless device and a second breathing apparatus;
receiving, from the second breathing apparatus, a third pressure value associated with the second breathing apparatus;
causing display of the third pressure value via the display of the wireless device; and providing a first screen via the display of the wireless device, wherein the first screen comprises:
a first user block associated with the first breathing apparatus; and
a second user block associated with the second breathing apparatus,
wherein the first user block comprises an indication that the first breathing apparatus is incapable of communicating with the wireless device.

36. The computer program product of claim 33, wherein the instructions are executable by the processing circuitry to further cause:
comparing the time discrete second pressure value to a first criterion; and
in response to determining, based on the comparing, that the time discrete second pressure value meets the first criterion:
generating an alert indicating that the first criterion has been met.
